(19) United States
(12) Patent Application Publication
(10) Pub. No.: US 2021/0100234 A1
(43) Pub. Date: Apr. 8, 2021

(54) Infusion reservoir for live wells

(71) Applicants: Andrew Nicholas Rogers, Fredericksburg, VA (US); Salen Bache, Fredericksburg, VA (US); Bruce R. Lee, Rappahannock Academy, VA (US)

(72) Inventors: Andrew Nicholas Rogers, Fredericksburg, VA (US); Salen Bache, Fredericksburg, VA (US); Bruce R. Lee, Rappahannock Academy, VA (US)

(21) Appl. No.: 16/602,426

(22) Filed: Oct. 3, 2019

(51) Int. Cl. A01K 97/05; A01K 99/00

(52) U.S. Cl. CPC A01K 97/05; A01K 99/00

(57) ABSTRACT

According to the present invention an infusion pump is provided within an angler's live well. The infusion pump readily dispenses additives into the water that fills the live well, counteracting the debilitating effects of ammonia released by the live fish. Upon activation by the angler the pump dispenses a controlled volume of liquid additive quickly and conveniently into the live well. In one embodiment a hemispherical bulb pump dispenses fluid additive. A second embodiment utilizing an electric pump is also disclosed. In a third embodiment a gravity fed infusion pump is described.

### CROSS REFERENCE TO RELATED APPLICATIONS

None

### STATEMENT REGARDING FEDERALLY SPONSORED RESEARCH OR DEVELOPMENT

Not Applicable

### THE NAMES OF PARTIES TO A JOINT RESEARCH AGREEMENT

None

### INCORPORATION-BY-REFERENCE OF MATERIAL SUBMITTED ON A COMPACT DISK

None

### BACKGROUND OF THE INVENTION

In todays world of tournament fishing the days catch is never harvested for mounting or consumption. Rather the fish are carefully kept as healthy as possible in a live well located in the fisherman's boat. Following a days fishing the angler checks in his total catch that is weighed and returned safely to the waters from where the fish were caught. The angler not only loses all credit for fish that die, but also the angler is penalized for fish that perish before they are weighed and released. Therefore there exists strong incentive for the tournament fisherman to maintain the conditions within the live well at an optimum level in particular for oxygen levels of the water within the live well. Also during the day as the fish occupy the live well they release ammonia that must be neutralized. Further the fish are protected by a coating that can be damaged by human contact resulting in fungal infections that are normally fatal. Normally the angler pours commercial liquid additives to the live well to counteract the toxins released by living fish including antifungals to counteract infections caused by human contact.

### BRIEF SUMMARY OF THE INVENTION

According to the present invention in two embodiments infusion pumps are provided that dispense additives to the angler's live well. The additives neutralize the waste products released by the live fish. Antifungals are also included with the additive. The infusion pump readily dispenses additives into the water that fills the live well, counteracting the debilitating effects of ammonia released by the live fish. The pump is manually controlled. Upon activation by the angler the pump dispenses a controlled volume of liquid additive quickly and conveniently into the live well.

In another embodiment a gravity fed reservoir including a spigot is attached to the top of the live well.

### BRIEF DESCRIPTION OF THE DRAWINGS

FIG. 1 shows the infusion pump according to the invention in combination with the live well of a tournament fishing boat.

FIG. 2 shows one embodiment of the infusion pump in detail. In this embodiment a hand operated pump dispenses a controlled volume into the live well without the need of electrical power.

FIG. 3 shows another embodiment of the infusion pump according to the invention. In this embodiment an electric pump dispenses a controlled volume of additive into the live well.

FIG. 4 shows a gravity fed dispensing apparatus including a spigot.

### DETAILED DESCRIPTION OF THE INVENTION

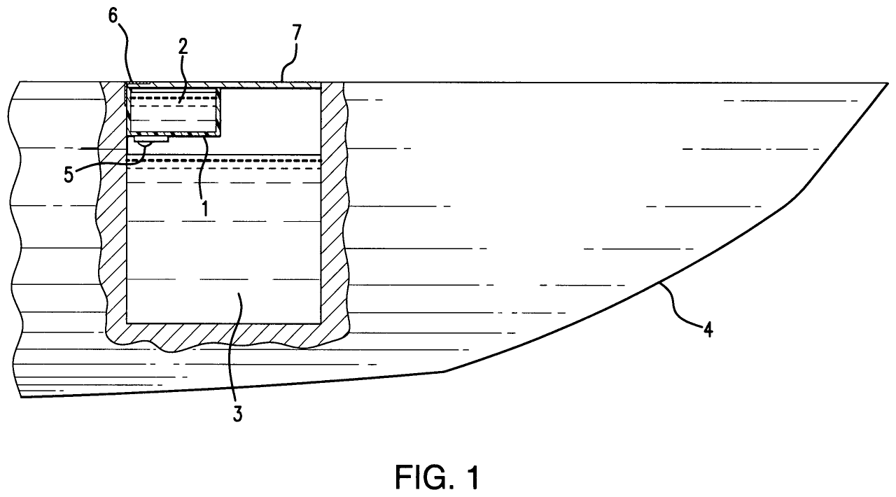

Referring to FIG. 1 infusion pump (1) is secured to the inside of the live well (3) located in fishing boat (4). Although the infusion pump of the invention is shown secured to a horizontal lid (7) of the live well, it is expressly understood that the infusion pump could be secured in any position within the live well so long as liquid additive is in fluid communication with the water in the live well. It is preferred that the infusion pump be above the water level in the live well; however the infusion pump is perfectly capable of operating even when submerged below the water in the live well (3). Bulb (5) is manually compressed with finger pressure forcing liquid additive from pump reservoir (2) to mix with water within live well (3). The operation and design of bulb (5) is similar to compression bulbs found on gasoline-powered equipment such as string fed weed trimmers. The horizontal lid (7) of the live well (3) is hinged at (6). When the infusion pump is located under the horizontal lid (7) of the live well, as in FIG. 1, the angler rotates the lid (7) about hinge (6) lifting the lid (7) of the live well to a vertical position. Bulb (5) is then compressed with finger pressure and additive drops by gravity into the live well (3). Of course when a live fish is caught and added to the days catch in the live well (7) the angler can take advantage of the opportunity and dispense additive when the lid (7) is in a vertical position.

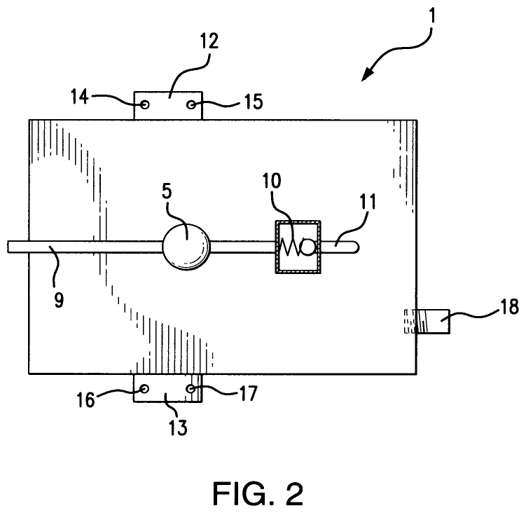

Referring to FIG. 2, infusion pump (1) is shown as the infusion pump appears as seen according the top view. Hemispherical bulb (5) protrudes from the bottom of infusion pump (1), although it is expressly understood that hemispherical bulb (5) could be located on any of the five exposed sides of infusion pump (1). When hemispherical bulb (5) is compressed with simple finger pressure, liquid additive from the infusion pump reservoir (2) is forced to flow through outlet tube (9) and into the water filled live well (3).

When the bulb (5) is pushed down, it pushes the air and liquid additive out of the tube (9). When the bulb (5) is released, the liquid additive is drawn up the tube (11), creating a negative pressure whereby the liquid additive is drawn into the inlet tube (11) in preparation for the next dispensing action.

In another embodiment a check valve can be added to ensure a one-way fluid path. At least one check valve (10) may be in fluid communication between hemispherical bulb (5) and inlet tube (11). The check valve is biased such that additive is forced through outlet tube (9) when hemispherical bulb (5) is compressed. Check valve (10), in fluid communication with hemispherical bulb (5) through inlet tube (11), is interposed between hemispherical bulb (5) and reservoir (2) of infusion pump (1). Check valve (10) prevents liquid additive from back flushing into reservoir (2). Simple spring biased ball valves are contemplated for check valve (10) although it is expressly understood that any conventional check valve or one-way valve is within the scope of the invention. Tabs (12) and (13) are provided on two of the sides of infusion pump (1) to attach infusion pump (1) to the inside surface of live well (3). Two holes (14) and (15) are located on left tab (12) and two holes (16) and (17) are located on right tab (13) for the purpose of providing points of attachment for the infusion pump (1) to the horizontal lid (7) of live well (3).

In use the angler presses hemispherical bulb (5) with his finger to dispense the exact volume of liquid additive desired. Fluid pressure generated by depressing hemispherical bulb (5) closes one-way valve (10) preventing fluid additive from back-flushing into reservoir (2), if a one-way valve is utilized. Liquid additive is forced into live well (3) through tube (9). When hemispherical bulb (5) is relaxed to its idle position, the volume of the uncompressed bulb increases creating a negative pressure, opening one way or check valve (10) and filling bulb (5). In this way the hemispherical bulb (5) is ready to dispense additive when desired.

A fluid input port (18) is provided in order to fill the fluid reservoir (2). A simple screw port with a fluid tight gasket adequately seals the reservoir (2). Any fluid tight port is contemplated within the scope of the invention.

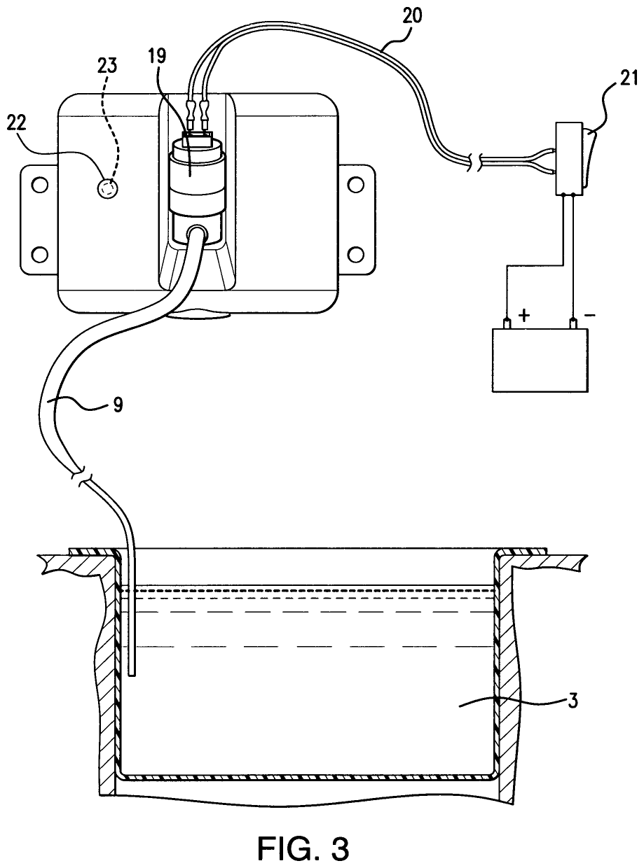

FIG. 3 shows an alternate embodiment of the infusion pump of the invention. In this embodiment an electrically powered pump (19) dispenses fluid additive to the live well (3). The electric pump (19) connects to the console of the fishing boat through a wiring harness (20). A rocker switch (21) provides an on-off switch. Because the electric pump (19) is unidirectional, there is no need for check valves with this embodiment, although check valves could be provided for added security against back flushing or diffusion into the fluid additive reservoir (2) (reservoir (2) best seen in FIG. 1).

A fluid input port (22) is provided in order to manually fill the fluid reservoir (2). A simple screw port with a fluid tight gasket (23) adequately seals the reservoir (2). Any fluid tight port is contemplated within the scope of the invention. However should the angler desire reservoir (2) could be filled without providing a port (22). Because electric pump (19) is capable of operating in either direction, by switching the positive and negative terminals connected to the electric pump (19), it is not necessary to provide a port to fill reservoir (2). That is by reversing the electric contacts to electric pump (19) the angler can fill reservoir (2) from a source of fluid additive without the requirement of a port. Of course when the reservoir (2) is filled in this manner check valves would be inappropriate. In use the angler simply activates the infusion pump using the rocker switch (21). A rocker switch that activates electric pump (19) in either direction is a preferred switch. The angler can readily control the volume of fluid additive delivered to live well (3) by controlling the amount of time electric pump (19) operates.

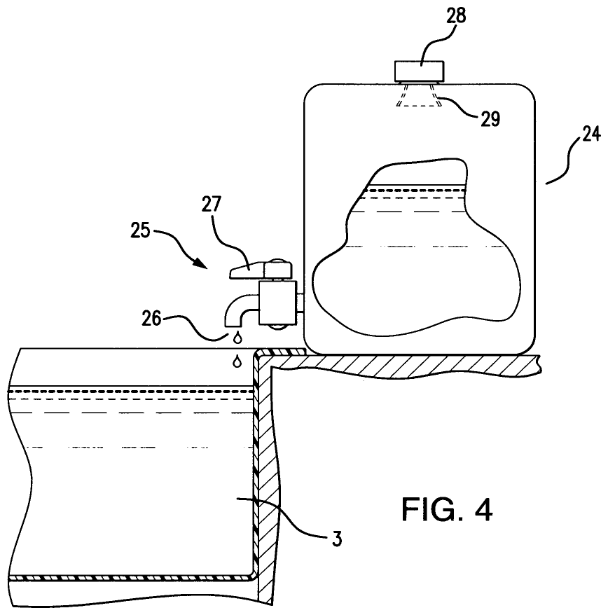

FIG. 4 shows a gravity fed fluid dispensing apparatus (24). In this embodiment no pump is necessary. Fluid dispensing apparatus (24) includes spigot (25). When horizontal lid (7) is rotated 90 degrees to an open position, spigot (25) is oriented such that outlet (26) will dispense additive directly into live well (3) by means of gravity. Or the fluid dispensing apparatus could be attached to horizontal lid (7) such that fluid additive can be dispensed when horizontal lid is rotated 180 degrees. Whatever the degree of rotation chosen for horizontal lid (7) when it is opened fluid dispensing apparatus (24) is adapted to drop fluid additive directly down into live well (3). A lever operated valve (27) controls the rate of fluid dispensing. A push button spring biased valve could equally be used to control fluid additive dispensing. The angler simply turns lever (27) to control additive dispensing. Port (28) is provided to fill reservoir (2). Fluid tight gasket (29) seals reservoir (2) when port (28) is in a closed position.

1. An infusion pump adapted to infuse fluid additive to a live well of a fishing boat, in order to maintain fish in the live well in a healthy and viable condition for tournament fishing, the infusion pump comprising a fluid tight fluid reservoir adapted to contain fluid additive, a hand operated hemispherical bulb pump attached through a surface of the fluid reservoir, a first tube providing fluid communication between fluid additive in the fluid additive reservoir and the hemispherical bulb pump, further including a second tube having an outlet providing fluid communication between the hemispherical bulb pump and the live well, and a fluid tight port adapted to fill the fluid additive reservoir.

2. The infusion pump of claim 1 including a one way check valve interposed between the first tube and the hemispherical bulb pump whereby fluid is prevented from back flushing fluid into the fluid additive reservoir when the hemispherical bulb pump is operated.

3. An infusion pump adapted to infuse fluid additive to a live well of a fishing boat, in order to maintain fish in the live well in a healthy and viable condition for tournament fishing, the infusion pump comprising a fluid tight fluid reservoir adapted to contain fluid additive, an electric pump in fluid communication with the fluid reservoir, further including a first tube having an outlet providing fluid communication between the electric pump and the live well, a wiring harness connected to an external power source and an electric switch interposed between the external power source and the electric pump for the purpose of controlling the electric pump, and a fluid tight port adapted to fill the fluid additive reservoir.

4. The infusion pump of claim 3 wherein the electric switch operates two ways adapted to reverse fluid flow through the electric pump whereby the fluid additive reservoir can be refilled from an external source.

5. An fluid dispensing apparatus adapted to be secured to a horizontal lid of a live well of a fishing boat wherein the fluid dispensing apparatus is adapted to dispense fluid additive to a live well of a fishing boat, in order to maintain fish in the live well in a healthy and viable condition for tournament fishing, the fluid dispensing apparatus comprising a fluid tight fluid reservoir adapted to contain fluid additive, the fluid dispensing apparatus including a spigot including a fluid outlet wherein when the horizontal lid is rotated to an open position, the spigot is oriented such that the fluid outlet will dispense additive directly into the live well by means of gravity, further including a port that serves to fill the fluid tight reservoir.

6. The fluid dispensing apparatus of claim 5 wherein the spigot includes a valve adapted to control the rate that fluid additive is dispensed.
